(19) United States
(12) Patent Application Publication
(10) Pub. No.: US 2026/0332347 A1
(43) Pub. Date: Oct. 22, 2026

(54) METHOD, DEVICE AND COMPUTER PROGRAM PRODUCT FOR WIRELESS COMMUNICATION

(71) Applicant: SANECHIPS TECHNOLOGY CO., LTD., Shenzhen (CN)

(72) Inventor: Bo SUN, Shenzhen (CN)

(21) Appl. No.: 19/113,224

(22) PCT Filed: Oct. 25, 2022
(86) PCT No.: PCT/CN2022/127436

§ 371 Date: Mar. 19, 2025

(51) Int. Cl. H04L 5/00; H04B 17/318

(52) U.S. Cl. CPC H04L 5/0053; H04B 17/318

(57) ABSTRACT

A wireless communication method is disclosed. The method may include: receiving, by a physical module of a wireless communication device, a Physical Protocol Data Unit (PPDU) including a protocol version (PV) field; and transmitting, by the physical module to a Medium Access Control (MAC) module of the wireless communication device, auxiliary information obtained based on the PPDU in response to a protocol version the PPDU compliant with indicated by a value of the PV field being not fully or partially supported by the wireless communication device to allow the MAC module to perform MAC proceeding according to the auxiliary information.

### CROSS-REFERENCE TO RELATED APPLICATION

This application is a national stage filing under 35 U.S.C. § 371 of international application number PCT/CN2022/127436, filed Oct. 25, 2022.

### TECHNICAL FIELD

This document is directed generally to wireless communications, and in particular to 5^{th} generation (5G) communications, 6^{th} generation (6G) communications, or wireless LAN.

### BACKGROUND

In wireless communication systems, new communication protocols are usually designed to be backward compatible with previous protocols. One of the examples is that IEEE (Institute of Electrical and Electronics Engineers) 802.11ax was defined to be backward compatible with IEEE 802.11ac which, in turn, was designed to be backward compatible with IEEE 802.11n which, in turn, was designed to be backward compatible with IEEE 802.11g/a, etc.

### SUMMARY

This document relates to methods, systems, and computer program products for wireless communication.

One aspect of the present disclosure relates to a wireless communication method. In an embodiment, the wireless communication method may include: receiving, by a physical module of a wireless communication device, a Physical Protocol Data Unit, PPDU, comprising a protocol version, PV, field; and transmitting, by the physical module to a Medium Access Control, MAC, module of the wireless communication device, auxiliary information obtained based on the PPDU in response to a protocol version the PPDU compliant with indicated by a value of the PV field being not fully or partially supported by the wireless communication device to allow the MAC module to perform MAC proceeding according to the auxiliary information.

Another aspect of the present disclosure relates to a wireless communication method. In an embodiment, the wireless communication method may include: receiving, by a Medium Access Control, MAC, module of a wireless communication device from a physical module of the wireless communication device, auxiliary information obtained based on a Physical Protocol Data Unit, PPDU, received by the physical module in response to a protocol version the PPDU compliant with indicated by a value of a PV field of the PPDU being not fully or partially supported by the wireless communication device; and performing, by the MAC module, MAC proceeding according to the auxiliary information obtained based on the PPDU.

Another aspect of the present disclosure relates to a wireless communication device. In an embodiment, the wireless communication device may include a communication unit and a processor. The processor is configured to: receive, by a physical module of the wireless communication device, a Physical Protocol Data Unit, PPDU, comprising a protocol version, PV, field; and transmit, by the physical module to a Medium Access Control, MAC, module of the wireless communication device, auxiliary information obtained based on the PPDU in response to a protocol version the PPDU compliant with indicated by a value of the PV field being not fully or partially supported by the wireless communication device to allow the MAC module to perform MAC proceeding according to the auxiliary information.

Another aspect of the present disclosure relates to a wireless communication device. In an embodiment, the wireless communication device may include a communication unit and a processor. The processor is configured to: receive, by a Medium Access Control, MAC, module of the wireless communication device from a physical module of the wireless communication device, auxiliary information obtained based on a Physical Protocol Data Unit, PPDU, received by the physical module in response to a protocol version the PPDU compliant with indicated by a value of a PV field of the PPDU being not fully or partially supported by the wireless communication device; and perform, by the MAC module, MAC proceeding according to the auxiliary information obtained based on the PPDU.

Various embodiments may preferably implement the following features:

Preferably, the auxiliary information comprises at least one of:
a bandwidth used by the PPDU;
a protected duration indicated within the PPDU;
an identifier of a transmitter transmitting the PPDU and a Basic Service Set Identifier, BSSID, the transmitter associated with;
an indication of a transmission direction;
a duration of the PPDU;
the value of the PV field of the PPDU or an indication that the value of the PV field is not supported; or
a received signal strength indicator, RSSI, obtained based on a received portion or a part of the received portion of the PPDU.

Preferably, the RSSI is obtained by measuring a portion of the PPDU transmitted before the PV field.

Preferably, at least one of the bandwidth used by the PPDU, the protected duration indicated within the PPDU, the identifier of the transmitter of the PPDU and the BSSID the transmitter associated with, the indication of the transmission direction, or the duration of the PPDU is indicated in a universal signaling symbol in the PPDU.

Preferably, the physical module marks the PPDU as an unknown format in response to the protocol version the PPDU compliant with indicated by the value of the PV field being not fully or partially supported by the wireless communication device.

Preferably, the physical module informs the MAC module that a PPDU of an unknown format is received in response to the protocol version the PPDU compliant with indicated by the value of the PV field being not fully or partially supported by the wireless communication device.

Preferably, the physical module keeps receiving the PPDU, stops receiving the PPDU and returns to a listening mode to check the channel availability or to receive any other PPDU, or enters a dozing mode in response to the protocol version the PPDU compliant with indicated by the value of the PV field being not fully or partially supported by the wireless communication device.

Preferably, the physical module keeps receiving the PPDU, stops receiving the PPDU and returns to a listening mode to check the channel availability or to receive any other PPDU, or enters a dozing mode according to a request received from the MAC module in response to the protocol version the PPDU compliant with indicated by the value of the PV field being not fully or partially supported by the wireless communication device.

Preferably, the physical module transmits an indication indicating an end of a reception of the PPDU.

Preferably, the physical module indicates to the MAC module the physical module's operation including one of: keeping receiving the PPDU, stopping receiving the PPDU and returning into a listening mode, or entering a dozing mode.

Preferably, the physical module transmits second auxiliary information to the MAC module, and the second auxiliary information is obtained during receiving a portion of the PPDU received after the PV field.

Preferably, the MAC module is informed by the physical module that a PPDU of an unknown format is received by the physical module in response to the protocol version the PPDU compliant with indicated by the value of the PV field being not fully or partially supported by the wireless communication device.

Preferably, the MAC module transmits a request to the physical module to control the physical module to keep receiving the PPDU, stops receiving the PPDU and returns to a listening mode to check a channel availability or to receive any other PPDU or enters a dozing mode in response to the protocol version the PPDU compliant with indicated by the value of the PV field being not fully or partially supported by the wireless communication device.

Preferably, the MAC module receives an indication indicating an end of a reception of the PPDU from the physical module.

Preferably, the MAC module receives second auxiliary information from the physical module, and the second auxiliary information corresponds to a portion of the PPDU after the PV field.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF DRAWINGS

The above and other aspects and their implementations are described in greater detail in the drawings, the descriptions, and the claims.

FIG. 1 shows a schematic diagram of a Physical Protocol Data Unit according to an embodiment of the present disclosure.

FIG. 2 shows schematic diagram of a protocol version field according to an embodiment of the present disclosure.

FIG. 3 shows an example of a schematic diagram of a wireless communication device according to an embodiment of the present disclosure.

FIG. 4 shows a flowchart of a wireless communication method according to an embodiment of the present disclosure.

FIG. 5 shows a flowchart of a wireless communication method according to an embodiment of the present disclosure.

### DETAILED DESCRIPTION

In standard design, a new standard or amendment standard is requested to provide mechanism for backward compatibility. For example, IEEE 802.11be under development is mandated to be backward compatible with IEEE 802.11ax, which, in turn, was designed to be backward compatible with IEEE 802.11ac which, in turn, was designed to be backward compatible with IEEE 802.11n which, in turn, was designed to be backward compatible with IEEE 802.11g/a, etc. In this way, an IEEE 802.11be compliant device could identify an IEEE 802.11ax compliant signal, an IEEE 802.11ac compliant signal, an IEEE 802.11n compliant signal, etc. However, an IEEE 802.11ax compliant device may not be able to identify an IEEE 802.11be compliant signal and an IEEE 802.11ac compliant device may not be able to identify an IEEE 802.11ax compliant signal.

In some embodiments, an STA (station) includes a PHY (physical) module and an MAC (Medium Access Control) module. In some embodiments, the PHY module is configured to proceed the RF (radio frequency) TX (transmission)/RX (reception), the PPDU (PHY Protocol Data Unit) TX/RX, and/or base-band operations. In some embodiments, the MAC module is configured to proceed upper layer operations.

In some embodiments, the functions of the PHY module and/or the MAC module may be performed by using one or more processors, but is not limited in this regard.

In some embodiments, a PPDU may include a preamble portion and a data portion. In some embodiments, the preamble portion may include a PV (Protocol Version) field and other signaling fields.

In some embodiments, the bit value of a PV field is set to a specific value corresponding to a specific protocol version with which the specific protocol defines the detailed format of a PPDU.

In some embodiments, when receiving a PPDU with a PV field setting to a specific value indicating a protocol version the PPDU compliant with is not supported (e.g., fully or partially supported) by the STA, the PHY module of the STA may identify the PPDU as a frame compliant with the protocol corresponding to the protocol version indicated by the value of the PV field, and mark this PPDU with an identifier for further PHY proceeding.

In some embodiments, when the value of the PV field indicates the PPDU is of a protocol version with which the STA does not support (e.g., fully or partially support), the mentioned further PHY proceeding may include identifying or obtaining information from the PPDU including at least one of below and reporting the identified information (e.g., auxiliary information) to the MAC module for further MAC proceeding:
the bandwidth used by the PPDU;
the protected duration indicated within the PPDU, which indicates the guaranteed duration for the transmission of the PPDU;
the identifier of the transmitter of the PPDU and the BSSID (Basic Service Set Identifier) the transmitter of the PPDU associated with;
the indication of the transmission direction of the PPDU (e.g., to AP (Access Point) or to Non-AP STA);
the duration of the PPDU, which indicates the actual duration for the transmission of the PPDU;
the value of the PV field of the PPDU or an indication that the protocol version the PPDU compliant with indicated by the value of the PV field is not supported; and/or
the received signal strength indicator (RSSI) of the PPDU.

In some embodiments, the RSSI of the PPDU is achieved or obtained by measuring a portion of the PPDU before the PV field.

In some embodiments, at least one of the bandwidth used by the PPDU, the protected duration indicated within the PPDU, the identifier of the transmitter of the PPDU and the BSSID the transmitter associated with, the indication of the transmission direction, or the duration of the PPDU is indicated in a universal signaling symbol in the PPDU.

In some embodiments, the MAC module performs medium access operations according to the auxiliary information. In some embodiments, the MAC module performs a wireless environment perception according to the auxiliary information. In some embodiments, the MAC module performs an access control scheme according to the auxiliary information. In some embodiments, the MAC module performs a bandwidth and/or channel management according to the auxiliary information, including a bandwidth adjustment and/or a channel switching.

Through such a configuration, benefits may be introduced including but not limited to:
a) enabling devices to measure the RSSI of wireless frames compliant with new protocols, so as to guarantee fair medium access based on current MAC mechanism; and
b) enabling devices to acquire some wireless environment information from wireless frames compliant with new protocols so as to allow the devices to perform better a wireless environment perception and better access control scheme based on current MAC mechanism. For an AP, this means the AP could perform better bandwidth and channel management, including bandwidth adjustment and channel switching, etc.

In the paragraphs below, details will be described along with examples, but the present disclosure is not limited to the examples below.

In some embodiments, a WLAN (Wireless Local Area Network) Basic Service Set (BSS) includes an AP and several Non-AP STAs associated with the AP. Both APs and Non-AP STAs could be understood as WLAN devices.

In some embodiments, both APs and Non-AP STAs support STA operations, including transmitting and receiving PPDUs.

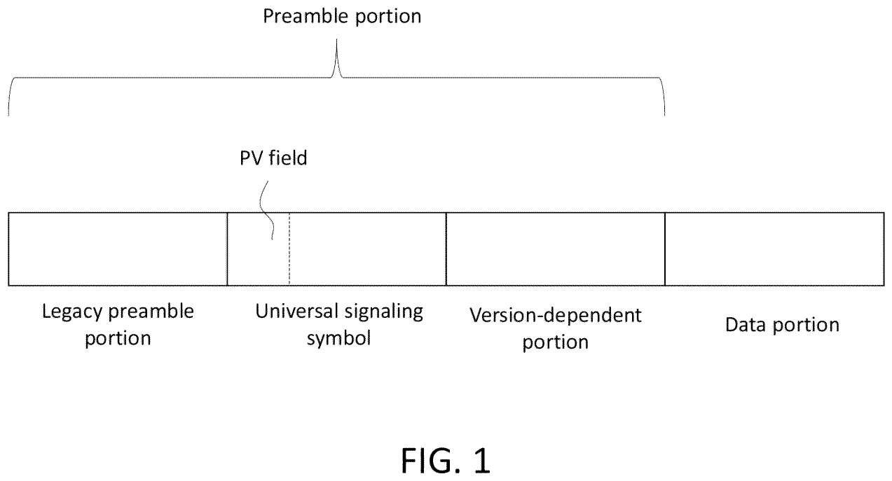

In some embodiments, as illustrated in FIG. 1, a PPDU may include a preamble portion and a data portion. The preamble portion includes at least one of a legacy preamble portion, a universal signaling symbol, and/or a version-dependent portion.

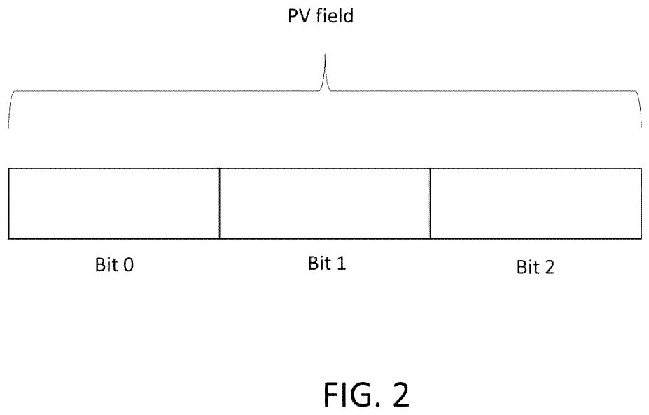

In some embodiments, the universal signaling symbol carries version-independent information. In some embodiment, as illustrated in FIG. 2, the universal signaling symbol includes a 3-bits Protocol Version field.

In some embodiments, a later transmission/receiving protocol version may define one value for the 3-bits Protocol Version field that has not been used in legacy protocols as the protocol version.

For example, as Table 1 below, the Protocol Version field for WLAN devices compliant with protocol version 0 can be defined as “000”.

TABLE 1

| bit 0 | bit 1 | bit 2 | meaning |
|---|---|---|---|
| 0 | 0 | 0 | protocol version 0 |

| | |
|---|---|
| Other | reserved |

As another example, as Table 2, the Protocol Version field for WLAN devices compliant with protocol version 2 can be defined as “010”.

TABLE 2

| bit 0 | bit 1 | bit 2 | meaning |
|---|---|---|---|
| 0 | 0 | 0 | protocol version 0 |
| 0 | 0 | 1 | protocol version 1 |
| 0 | 1 | 0 | protocol version 2 |

| | |
|---|---|
| Other | reserved |

In some embodiments, when a WLAN device receives a PPDU and the WLAN device's PHY module successfully decodes the legacy preamble portion and the universal signaling symbol identifies a PV field value that has not been defined (e.g., the protocol version the PPDU compliant with indicated by the value of the PV field being not fully or partially supported by the WLAN device), the PHY module may mark this PPDU as an unknown format.

Meanwhile, in some embodiments, the PHY module may measure the signal strength over the signal portion of the received PPDU before the universal signaling and take the measurement result as legacy RSSI.

In some embodiments, when a PPDU is identified as an unknown format (e.g., the protocol version the PPDU compliant with indicated by the value of the PV field being not fully or partially supported by the WLAN device), the PHY module may continue to identify the information in the universal signaling symbol. Then, the PHY module informs the MAC module that a PPDU of an unknown format is received with at least one of the following auxiliary information for the MAC module's further proceeding:
the value of the PV field of the PPDU or an indication that the protocol version the PPDU compliant with indicated by the value of the PV field is not supported;
the bandwidth information indicated in the universal signaling symbol of the PPDU;
the protected duration indicated in the universal signaling symbol of the PPDU, which indicates the guaranteed duration for the transmission of the PPDU;
the identifier of the BSSID the transmitter associated with, as indicated in the universal signaling symbol of the PPDU;
the indication of the transmission direction (e.g., to AP or to Non-AP STA), as indicated in the universal signaling symbol of the PPDU;
the duration of the PPDU indicated in the universal signaling symbol of the PPDU, which indicates the actual duration for the transmission of the PPDU; and/or
the legacy RSSI.

In some embodiments, in addition to sending the auxiliary information to the MAC module (e.g., after sending the auxiliary information to the MAC module), the PHY module may keep the receiving (or listening mode) mode for receiving the PPDU till the end of the PPDU.

In some embodiments, in addition to sending the auxiliary information to the MAC module (e.g., after sending the auxiliary information to the MAC module), the PHY module may stop receiving the rest of the signal and return to a listening mode to check a channel availability or to receive another PPDU and resume the CCA (Clear Channel Assessment) or another channel status detection process.

In some embodiments, in addition to sending the auxiliary information to the MAC module (e.g., after sending the auxiliary information to the MAC module), the PHY module may enter a dozing mode.

In some embodiments, the MAC module may transmit a request to the PHY module to control the PHY module to keep receiving the PPDU, stops receiving the PPDU and returns to a listening mode, or enters a dozing mode in response to the protocol version the PPDU compliant with indicated by the value of the PV field being not fully or partially supported by the WLAN device.

For example, in some embodiments, the MAC module may indicate the PHY module to proceed the receiving of the rest of the PPDU with a request (e.g., including designated parameters).

In some embodiments, the MAC module may indicate the PHY module to stop receiving and resuming CCA or another medium access process with another request (e.g., including designated parameters).

In some embodiments, the MAC module may indicate the PHY module to enter the dozing mode with another request (e.g., including designated parameters).

In some embodiments, when receiving an indication or a request (e.g., designated parameters) from the MAC module, the PHY module may perform the operation as requested by the indication or request according to the designated parameters.

In some embodiments, the PHY module may transmit an indication to the MAC module at the end of the receiving of the PPDU. In some embodiments, the indication indicates the ending of the receiving of the PPDU.

In some embodiments, the PHY module may report to the MAC module second auxiliary information achieved or obtained during receiving the rest of the PPDU (e.g., a portion of the PPDU after the PV field).

In some embodiments, the MAC module may indicate the PHY module to transmit the second auxiliary information achieved or obtained during receiving the rest of the PPDU.

In some embodiments, the second auxiliary information may include, for example, RSSI of the rest part of the PPDU.

In some embodiments, when receiving indications from the MAC module, the PHY module stops receiving and resuming the CCA or another medium access process.

In accordance with some embodiments of the present disclosure, if a PPDU carries a PV field value that is not defined, the PHY module marks the PPDU as an unknown format.

In accordance with some embodiments of the present disclosure, the PHY module informs the MAC module that a PPDU of an unknown format is received.

In accordance with some embodiments of the present disclosure, the PHY module identifies information in the universal signaling symbol and reports the identified information to the MAC module together with the unknown format information.

In accordance with some embodiments of the present disclosure, the PHY module reports the legacy RSSI achieved or obtained in measurement of a signal portion of the PPDU before the universal signaling symbol.

In accordance with some embodiments of the present disclosure, the MAC module may indicate the PHY module to proceed the receiving of the rest portion of the PPDU with designated parameters.

In accordance with some embodiments of the present disclosure, the PHY module may report to the MAC module the information achieved or obtained during the receiving of the rest portion of the PPDU as requested by the MAC module.

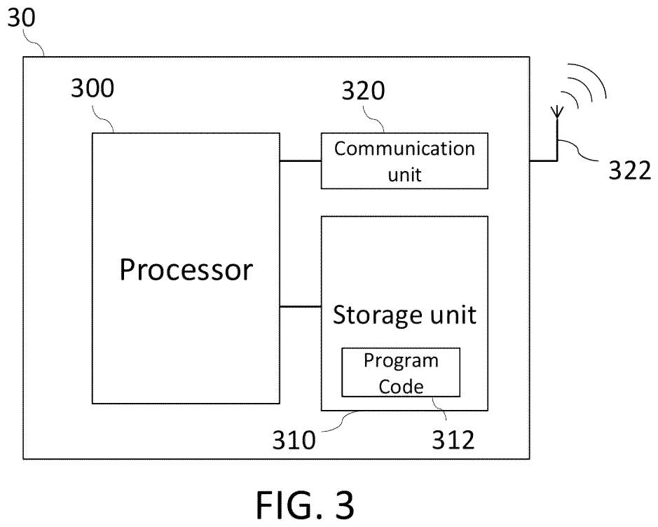

FIG. 3 relates to a diagram of a wireless communication device 30 according to an embodiment of the present disclosure. The wireless communication device 30 may be a station, (STA), an access point (AP), or a non-access point (non-AP), and is not limited herein. The wireless communication device 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication device 30, e.g., by executing the program code 312.

The communication unit 320 may be a transceiver. The communication unit 320 may as an alternative or in addition be combining a transmitting unit and a receiving unit configured to transmit and to receive, respectively, signals to and from another wireless communication device.

In some embodiments, the wireless communication device 30 may include a physical module and an MAC module. In some embodiments, the functions of the physical module may be performed by the processor 300. In some embodiments, the functions of the MAC module may be performed by the processor 300.

In some embodiments, the wireless communication device 30 may be used to perform the operations of the AP, the Non-AP STA or the WLAN device described above. In some embodiments, the processor 300 and the communication unit 320 collaboratively perform the operations described above. For example, the processor 300 performs operations and transmit or receive signals, message, and/or information through the communication unit 320.

A wireless communication method is also provided according to an embodiment of the present disclosure. In an embodiment, the wireless communication method may be performed by using a wireless communication device. In an embodiment, the wireless communication device may be implemented by using the wireless communication device 30 described above, but is not limited thereto.

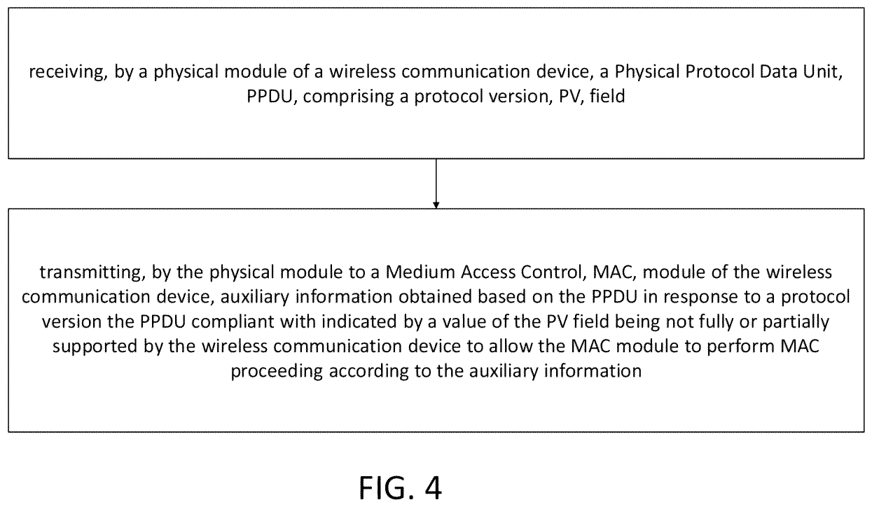

Referring to FIG. 4, in an embodiment, the wireless communication method includes: receiving, by a physical module of a wireless communication device, a Physical Protocol Data Unit, PPDU, comprising a protocol version, PV, field; and transmitting, by the physical module to a Medium Access Control, MAC, module of the wireless communication device, auxiliary information obtained based on the PPDU in response to a protocol version the PPDU compliant with indicated by a value of the PV field being not fully or partially supported by the wireless communication device to allow the MAC module to perform MAC proceeding according to the auxiliary information.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication device. In an embodiment, the wireless communication device may be implemented by using the wireless communication device 30 described above, but is not limited thereto.

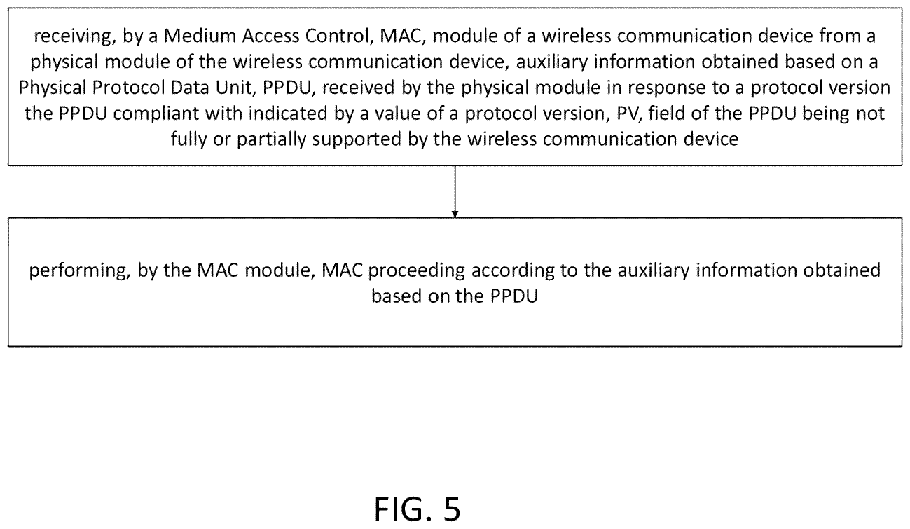

Referring to FIG. 5, in an embodiment, the wireless communication method includes receiving, by a Medium Access Control, MAC, module of a wireless communication device from a physical module of the wireless communication device, auxiliary information obtained based on a Physical Protocol Data Unit, PPDU, received by the physical module in response to a protocol version the PPDU compliant with indicated by a value of a PV field of the PPDU being not fully or partially supported by the wireless communication device; and performing, by the MAC module, MAC proceeding according to the auxiliary information obtained based on the PPDU.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a physical module of a wireless communication device, a Physical Protocol Data Unit (PPDU) comprising a protocol version (PV) field; and
transmitting, by the physical module to a Medium Access Control (MAC) module of the wireless communication device, auxiliary information obtained based on the PPDU in response to a protocol version the PPDU compliant with indicated by a value of the PV field being not fully or partially supported by the wireless communication device to allow the MAC module to perform MAC proceeding according to the auxiliary information.

2. The wireless communication method of claim 1, wherein the auxiliary information comprises at least one of:
a bandwidth used by the PPDU;
a protected duration indicated within the PPDU;
an identifier of a transmitter transmitting the PPDU and a Basic Service Set Identifier, BSSID, the transmitter associated with;
an indication of a transmission direction;
a duration of the PPDU;
the value of the PV field of the PPDU or an indication that the protocol version the PPDU compliant with indicated by the value of the PV field being not fully or partially supported by the wireless communication device; or
a received signal strength indicator, RSSI, obtained based on a received portion or a part of the received portion of the PPDU.

3. The wireless communication method of claim 2, wherein the RSSI is obtained by measuring a portion of the PPDU transmitted before the PV field.

4. The wireless communication method of claim 2, wherein at least one of the bandwidth used by the PPDU, the protected duration indicated within the PPDU, the identifier of the transmitter of the PPDU and the BSSID the transmitter associated with, the indication of the transmission direction, or the duration of the PPDU is indicated in a universal signaling symbol in the PPDU.

5. The wireless communication method of claim 1, wherein the physical module marks the PPDU as an unknown format in response to the protocol version the PPDU compliant with indicated by the value of the PV field being not fully or partially supported by the wireless communication device.

6. The wireless communication method of claim 1, wherein the physical module informs the MAC module that a PPDU of an unknown format is received in response to the protocol version the PPDU compliant with indicated by the value of the PV field being not fully or partially supported by the wireless communication device.

7. The wireless communication method of claim 1, wherein the physical module keeps receiving the PPDU, stops receiving the PPDU and returns to a listening mode, or enters a dozing mode in response to the protocol version the PPDU compliant with indicated by the value of the PV field being not fully or partially supported by the wireless communication device.

8. The wireless communication method of claim 1, wherein the physical module keeps receiving the PPDU, stops receiving the PPDU and returns to a listening mode to check a channel availability or to receive any other PPDU or enters a dozing mode according to a request received from the MAC module in response to the protocol version the PPDU compliant with indicated by the value of the PV field being not fully or partially supported by the wireless communication device.

9. The wireless communication method of claim 1, wherein the physical module transmits an indication indicating an end of a reception of the PPDU.

10. The wireless communication method of claim 1, wherein the physical module transmits second auxiliary information to the MAC module, and the second auxiliary information is obtained during receiving a portion of the PPDU received after the PV field.

11. A wireless communication method comprising:
receiving, by a Medium Access Control (MAC) module of a wireless communication device from a physical module of the wireless communication device, auxiliary information obtained based on a Physical Protocol Data Unit (PPDU) received by the physical module in response to a protocol version the PPDU compliant with indicated by a value of a protocol version (PV) field of the PPDU being not fully or partially supported by the wireless communication device; and
performing, by the MAC module, MAC proceeding according to the auxiliary information obtained based on the PPDU.

12. The wireless communication method of claim 11, wherein the auxiliary information comprises at least one of:
a bandwidth used by the PPDU;
a protected duration indicated within the PPDU;
an identifier of a transmitter transmitting the PPDU and a Basic Service Set Identifier, BSSID, the transmitter associated with;
an indication of a transmission direction;
a duration of the PPDU;
the value of the PV field of the PPDU or an indication that the protocol version the PPDU compliant with indicated by the value of the PV field being not fully or partially supported by the wireless communication device; or
a received signal strength indicator, RSSI, obtained based on a received portion or a part of the received portion of the PPDU.

13. The wireless communication method of claim 11, wherein the MAC module is informed by the physical module that a PPDU of an unknown format is received by the physical module in response to the protocol version the PPDU compliant with indicated by the value of the PV field being not fully or partially supported by the wireless communication device.

14. The wireless communication method of claim 11, wherein the MAC module transmits a request to the physical module to control the physical module to keep receiving the PPDU, stops receiving the PPDU and returns to a listening mode to check a channel availability or to receive any other PPDU or enters a dozing mode in response to the protocol version the PPDU compliant with indicated by the value of the PV field being not fully or partially supported by the wireless communication device.

15. The wireless communication method of claim 11, wherein the MAC module receives an indication indicating an end of a reception of the PPDU from the physical module.

16. The wireless communication method of claim 11, wherein the MAC module receives second auxiliary information from the physical module, and the second auxiliary information corresponds to a portion of the PPDU after the PV field.

17. A wireless communication device, comprising:
a communication unit; and
a processor configured to: receive, by a physical module of the wireless communication device, a Physical Protocol Data Unit (PPDU) comprising a protocol version (PV) field; and transmit, by the physical module to a Medium Access Control (MAC) module of the wireless communication device, auxiliary information obtained based on the PPDU in response to a protocol version the PPDU compliant with indicated by a value of the PV field being not fully or partially supported by the wireless communication device to allow the MAC module to perform MAC proceeding according to the auxiliary information.

18. (canceled)

19. A wireless communication device, comprising:
a communication unit; and
a processor configured to: perform a wireless communication method of claim 11.

20. (canceled)

21. (canceled)

22. A non-transitory computer-readable medium storing a computer-readable program medium code which, when executed by a processor, causes the processor to implement a wireless communication method recited in claim 1.

23. A non-transitory computer-readable medium storing a computer-readable program medium code which, when executed by a processor, causes the processor to implement a wireless communication method recited in claim 11.
